(19) United States
(12) Patent Application Publication
(10) Pub. No.: US 2015/0149616 A1
(43) Pub. Date: May 28, 2015

(54) SERVER AND SHARE LINK MANAGEMENT METHOD THEREOF

(71) Applicant: Institute For Information Industry, Taipei (TW)

(72) Inventors: Ko-Yang WANG, Taipei City (TW); Phoenix LEE, New Taipei City (TW); Ying-You LIN, Bade City (TW); Bang-Min SHIUE, Taipei City (TW)

(73) Assignee: Institute For Information Industry, Taipei (TW)

(21) Appl. No.: 14/092,500

(22) Filed: Nov. 27, 2013

(51) Int. Cl. G06F 11/30

(52) U.S. Cl. CPC G06F 11/3041
USPC 709/224

(57) ABSTRACT

A server and a share link management method are provided. The server generates a first share link in response to a request, and generates a first workflow according to the first share link. The server transmits the first share link to at least one electronic device via a network according to the first workflow. The server monitors at least one first status which is generated by the at least one electronic device in response to the first share link, and adjusts the first workflow according to the at least one first status. The share link management method is applied to the server to implement the aforesaid operations.

### FIELD

The present invention relates to a server and a management method thereof. More particularly, the present invention relates to a server and a share link management method thereof.

### BACKGROUND

Over recent years, sharing information with others via a share link has become a popular social behavior online. For example, when a user accesses content (such as articles, pictures, audios, videos, etc.) provided by an Internet content provider/server via a browser on the Internet and wants to share the content with others, the user may request the Internet content provider/server to generate and transmit a share link connected to the content so that the user can share the content with the others via the share link. Likewise, when a user has stored a file (such as articles, pictures, audios and videos, etc.) in a storage server and wants to share the file with others, the user may request the storage server to generate and transmit a share link connected to the file so that the user can share the file with the others via the share link.

When a user generates and transmits a share link for content sharing, he may wonder what is happened. For example, the user may wonder whether the share link is received successfully; the user may wonder when the share link arrives; or the user may wonder whether the recipient wants to respond to the share link and what is the response. Without the information, the user can not properly make further social behaviors with others who receive the share link transmitted from the user. Nevertheless, conventional share link procedures merely provide a simpler solution for content sharing but they do not provide the user with the information; therefore, they can not fully meet the needs of online socials.

In view of this, it is important to provide a smarter share link procedure to meet the needs of online socials.

### SUMMARY

An objective of certain embodiments of the present invention is to provide a smarter share link procedure to meet the needs of online socials.

To this end, certain embodiments of the present invention provide a server. The server comprises a processing unit, a network interface unit and a monitor unit. The network interface is electrically connected with the processing unit and the monitor unit is electrically connected with the network interface unit and the monitor unit. The processing unit is configured to generate a first share link in response to a request and generate a first workflow according to the first share link. The network interface unit is configured to transmit the first share link to at least one electronic device via a network according to the first workflow. The monitor unit is configured to monitor at least one first status which is generated by the at least one electronic device in response to the first share link. The processing unit is further configured to adjust the first workflow according to the at least one first status.

To this end, certain embodiments of the present invention provide a share link management method for a server. The server comprises a processing unit, a network interface unit and a monitor unit. The network interface is electrically connected with the processing unit and the monitor unit is electrically connected with the network interface unit and the monitor unit. The share link management method comprises the following steps:

(a1) generating a first share link in response to a request by the processing unit;

(a2) generating a first workflow according to the first share link by the processing unit;

(a3) transmitting the first share link to at least one electronic device via a network according to the first workflow by the network interface unit;

(a4) monitoring at least one first status which is generated by the at least one electronic device in response to the first share link by the monitor unit; and

(a5) adjusting the first workflow according to the at least one first status by the processing unit.

To sum up, certain embodiments of the present invention provide a server and a share link management method for a server. The server and the share link management method pre-generate a workflow for the sequent social behaviors between the server and other electronic devices according to a share link which is generated in response to a request; monitor various statuses which are generated by the electronic devices in response to the share link; and adaptively and dynamically adjust the workflow according to the monitored statuses to deal with different needs of the electronic devices.

Unlike conventional share link procedures, the present invention can provide information which indicates what is happened after a shark link is transmitted through monitoring various statuses which are generated by the electronic devices in response to the share link. In addition, the present invention generates a workflow which is adjustable according to the monitored statuses to deal with different needs of the electronic devices. Consequently, in contrast with conventional share link procedures, the present invention effectively provides a smarter share link procedure to meet the needs of online social.

The detailed technology and preferred embodiments implemented for the present invention are described in the following paragraphs accompanying the appended drawings for persons skilled in the art to well appreciate the features of the claimed invention.

### BRIEF DESCRIPTION OF THE DRAWINGS

FIG. 1 is a schematic view of a network system according to a first embodiment of the present invention;

FIG. 2A is a diagram illustrating an example of the first workflow according to the first embodiment of the present invention;

FIG. 2B is a diagram illustrating an example of various actions for each process of the first workflow;

FIG. 3A is a diagram illustrating an example of the second workflow according to the first embodiment of the present invention;

FIG. 3B is a diagram illustrating an example of various actions for each process of the second workflow; and

FIG. 4 is a flowchart of a share link management method according to a second embodiment of the present invention.

### DETAILED DESCRIPTION

The present invention may be explained with reference to the following example embodiments. However, these example embodiments are not intended to limit the present invention to any specific examples, embodiments, environments, applications or implementations described in these embodiments. Therefore, the description of these example embodiments is only for the purpose of illustration rather than to limit the present invention. In the following embodiments and the attached drawings, elements not directly related to the present invention are omitted from depiction. In addition, the dimensional relationships among individual elements in the attached drawings are illustrated only for ease of understanding, but not to limit the actual scale.

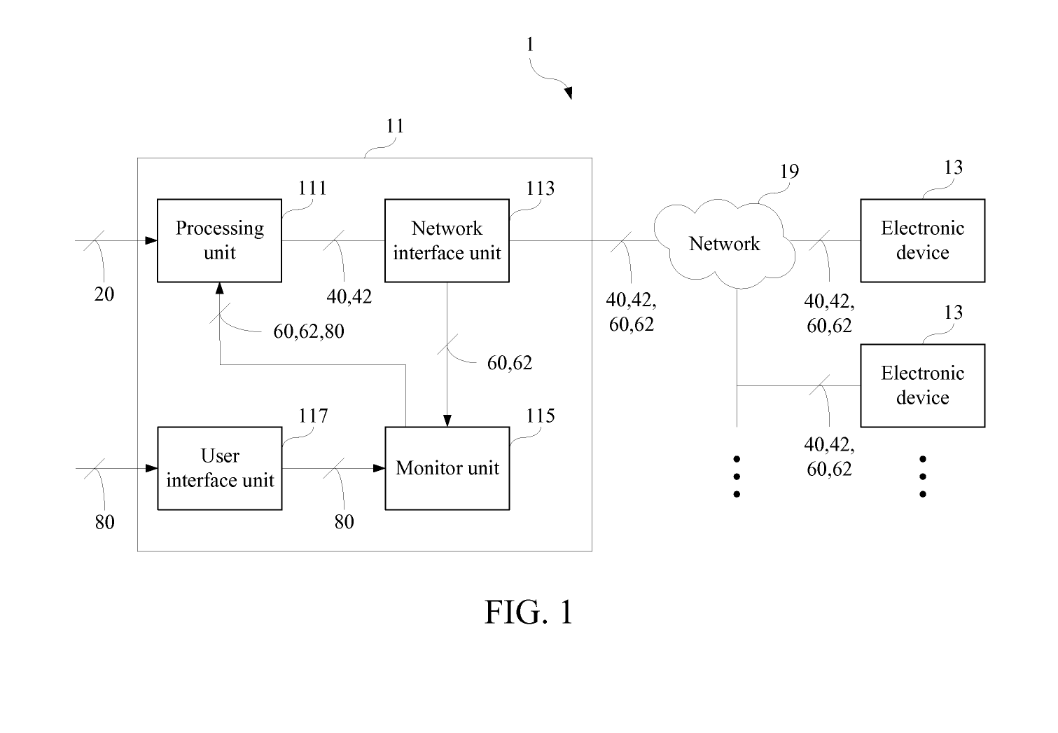

A first embodiment of the present invention is a server. FIG. 1 illustrates a network system 1 according to the first embodiment. The network system 1 comprises a server 11 and at least one electronic device 13 (i.e., one or a plurality of electronic devices). In the network system 1, the server 11 and the at least one electronic device 13 communicates with each other via a network 19. The network system 1 may be regarded as anyone of conventional network systems. For convenient, the network system 1 is considered to be a cloud-based network system in the first embodiment. In addition, the server 11 and the at least one electronic device 13 each may be regarded as anyone of conventional electronics such as a personal computer, a tablet computer, a smart phone, a notebook computer, and the like.

The server 11 may comprise a processing unit 111, a network interface unit 113 and a monitor unit 115. The network interface unit 113 is electrically connected with the processing unit 111, while the monitor unit 115 is electrically connected with the network interface unit 113 and the processing unit 111. The server 11 may optionally comprise a user interface unit 117 electrically connected with the monitor unit 115. The server 11 may be regarded as anyone of conventional server. For convenient, the server 11 is considered to be a cloud-based storage server in the first embodiment.

The processing unit 111 is configured to generate a first share link 40 in response to a request 20. For example, when a person wants to share a file stored in the server 11 with others, he may ask the server 11 via the request 20 to generate the first share link 40 connected to the file so that he can share the file with the others via the first share link 40. The user may use the server 11 to directly generate the request 20 or use another device (not shown) connected to the server 11 to generate the request 20 and sends it to the server 11.

Upon generating the first share link 40, the processing unit 111 is further configured to generate a first workflow according to the first share link 20, and then the network interface unit 113 is configured to transmit the first share link 40 to the at least one electronic device 13 via the network 19 according to the first workflow. Upon transmitting the first share link 40, the monitor unit 115 is configured to monitor at least one first status 60 which is generated by the at least one electronic device 13 in response to the first share link 40. The processing unit 111 may provide access permission to the at least one electronic device 13 via the network interface unit 113 if the at least one electronic device 13 transmits an access request in response to the first share link 40. The processing unit 111 is further configured to adjust the first workflow according to the at least one first status 60.

Upon transmitting the first share link 40, if the user interface 117 is considered, the monitor unit 115 is further configured to monitor at least one user input 80 (i.e., one or a plurality of user inputs 80) which is generated by at least one user (i.e., one or a plurality of users) via the user interface 117 in response to the first share link 40, and the processing unit 111 is further configured to adaptively and dynamically adjust the first workflow according to the at least one user input 80. The at least one user may be a person who is controlling one electronic device 13, and he can actively send a feedback (i.e., a user input 80) to the server 11 via the user interface 117 in response to the first share link 40. The user interface 117 may comprise a web platform to receive and record any feedbacks which the at least one user has submitted. The web platform may also provide a representation of access permission if the at least one electronic device 13 transmits an access request in response to the first share link 40.

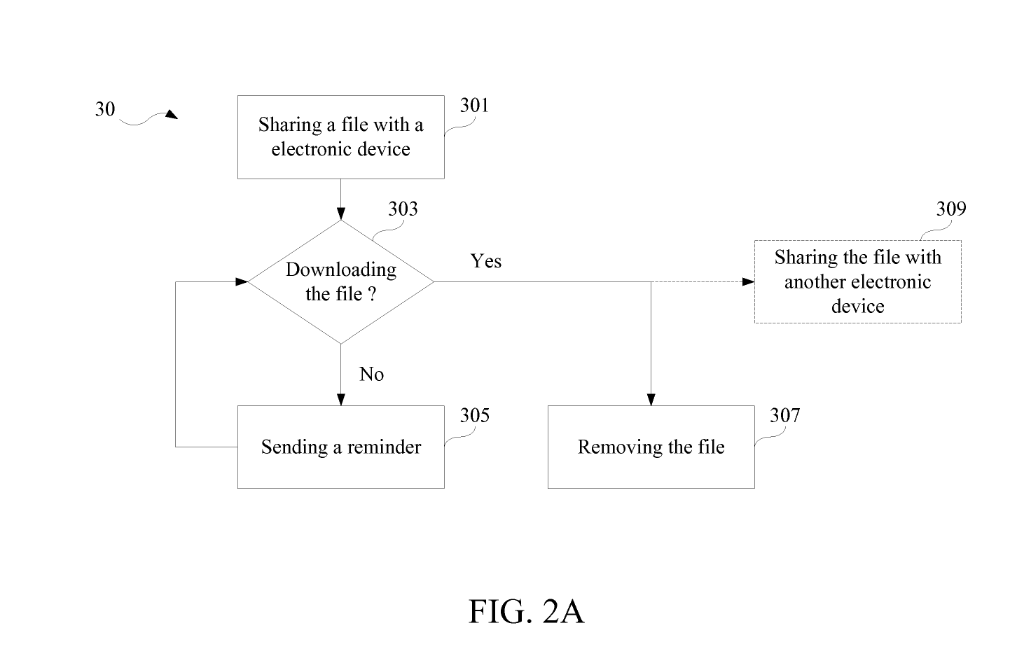

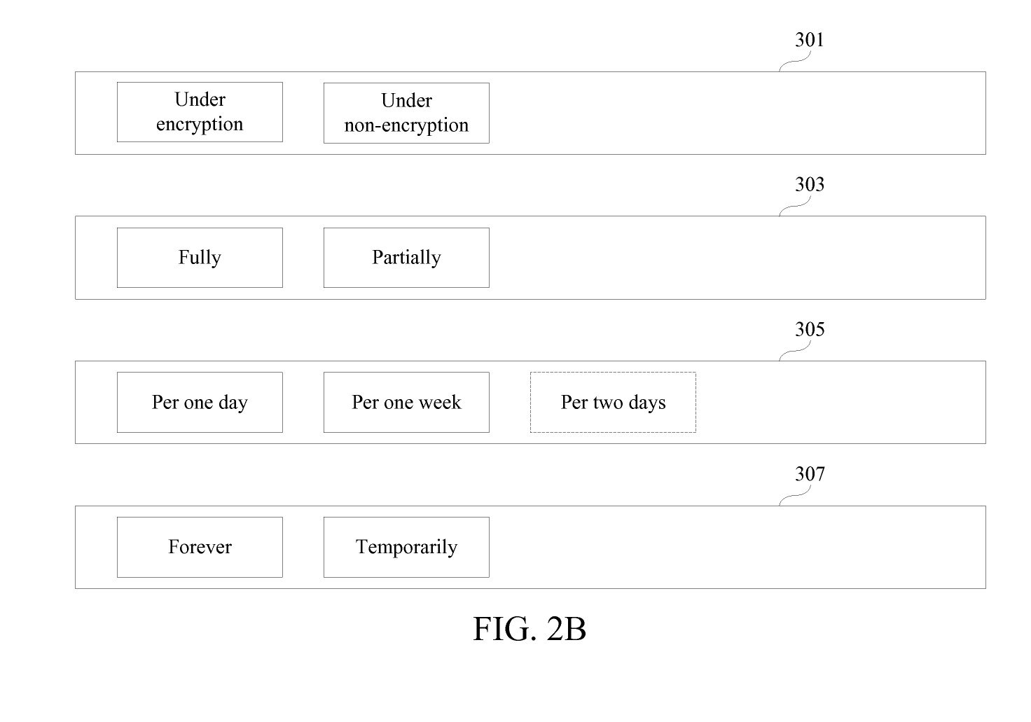

The first workflow may comprise at least one process (i.e., one or a plurality of processes). FIG. 2A is a diagram illustrating an example of the first workflow according to the first embodiment, where the first workflow 30 is only for the purpose of illustration rather than limitation. As shown in FIG. 2A, the first workflow 30 comprises a process 301, a process 303, a process 305 and a process 307. The process 301 is executed to share a file with one electronic device 13, while the process 303 is executed to determine whether the file is downloaded by the electronic device 13. If the determination of the process 303 is negative, the process 305 is executed to send a reminder to the electronic device 13 and then go back to the process 303. If the determination of the process 303 is positive, the process 307 is executed to remove the file from the server 11.

Each process of the first workflow 30 may be executed with at least one action (i.e., one or a plurality of actions). FIG. 2B is a diagram illustrating an example of various actions for each process of the first workflow 30, where the presented actions are only for the purpose of illustration rather than limitation. As shown in FIG. 2B, the process 301 may be executed to share the file with the electronic device 13 under encryption or under non-encryption. The former means that the electronic device 13 can directly open the file after downloading it from the server 11. On the contrary, the later means that the electronic device 13 needs a password to open the file after downloading it from the server 11.

Likewise, the process 303 may be executed to determine whether the file is fully or partially downloaded by the electronic device 13. Specifically, the former means that the determination of the process 303 is positive only when the file has been completely downloaded into the electronic device 13. On the contrary, the later means that the determination of the process 303 is positive even if the electronic device 13 just starts to download the file or only a part of the file has been downloaded into the electronic device 13.

Moreover, the process 305 may also be executed to send a reminder to the electronic device 13 per one day or one week so that the reminder can be sent at two different intervals. The process 307 may also be executed to remove the file from the server 11 forever or temporarily according to different conditions.

A further explanation will be presented hereafter based on the assumption that each process of the first workflow 30 is executed with its first action. Under the assumption, the network interface unit 113 may transmit the first share link 40 connected to the file to the electronic device 13 via the network 19 under encryption during the process 301. Next, to determine whether the file is fully download by the electronic device 13 during the process 303, the monitor unit 115 may continuously monitor a first status 60 which is generated by the electronic device 13 in response to the first share link 40 and/or at least one user input 80 which is generated by at least one user via the user interface 117 in response to the first share link 40.

If one first status 60 which is generated by the electronic device 13 in response to the first share link 40 or one user input 80 which is generated by a user via the user interface 117 in response to the first share link 40 indicates that the electronic device 13 has fully downloaded the file, the processing unit 111 may remove the file from the server 11 forever. Otherwise, if the first status 60 or the user input 80 indicates that the electronic device 13 has not downloaded the file yet, the processing unit 111 may send a reminder to the electronic device 13 via the network interface unit 113 per one day.

During the first workflow 30, the processing unit 111 is further configured to adaptively and dynamically adjust the first workflow 30 according to the at least one first status 60 and/or the at least one user input 80. Specifically, the processing unit 111 can create a new action, or change the current actions for each process in the first workflow 30 according to the at least one first status 60 and/or the at least one user input 80. The processing unit 111 can also create a new process, or change the current processes in the first workflow 30 according to the at least one first status 60 and/or the at least one user input 80.

For example, if one first status 60 which is generated by the electronic device 13 in response to the first share link 40 or one user input 80 which is generated by a user via the user interface 117 in response to the first share link 40 indicates that any files sent to the electronic device 13 does not need to be encrypted, the processing unit 111 will adjust the processor 301 by changing its first action with second action for the electronic device 13 so that the network interface unit 113 transmits the first share link 40 connected to the file or other files to the electronic device 13 via the network 19 under non-encryption during the process 301 after that.

For example, if one first status 60 which is generated by the electronic device 13 in response to the first share link 40 or one user input 80 which is generated by a user via the user interface 117 in response to the first share link 40 indicates that the transmission interval of reminders needs to be increased a bit, the processing unit 111 will create a new action “per two days” for the process 305 as shown in FIG. 2B so that the processing unit 111 sends a reminder to the electronic device 13 via the network interface unit 113 per two days after that.

For example, if one first status 60 which is generated by the electronic device 13 in response to the first share link 40 or one user input 80 which is generated by a user via the user interface 117 in response to the first share link 40 indicates that another electronic device 13 needs the file, the processing unit 111 will create a new process 309 to share the file with the other electronic device 13 in the first workflow 30 as shown in FIG. 2A so that the network interface unit 113 transmits the first share link 40 connected to the file to the other electronic device 13 via the network 19 during the process 309. Similar to the other processes of the first workflow 30, the process 309 may be executed with one or plurality of actions (not shown).

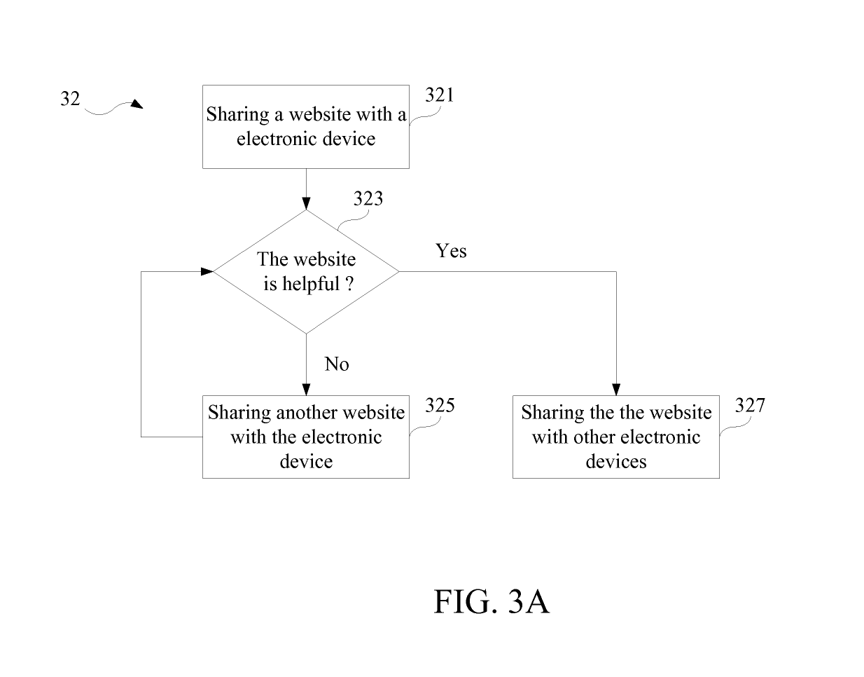

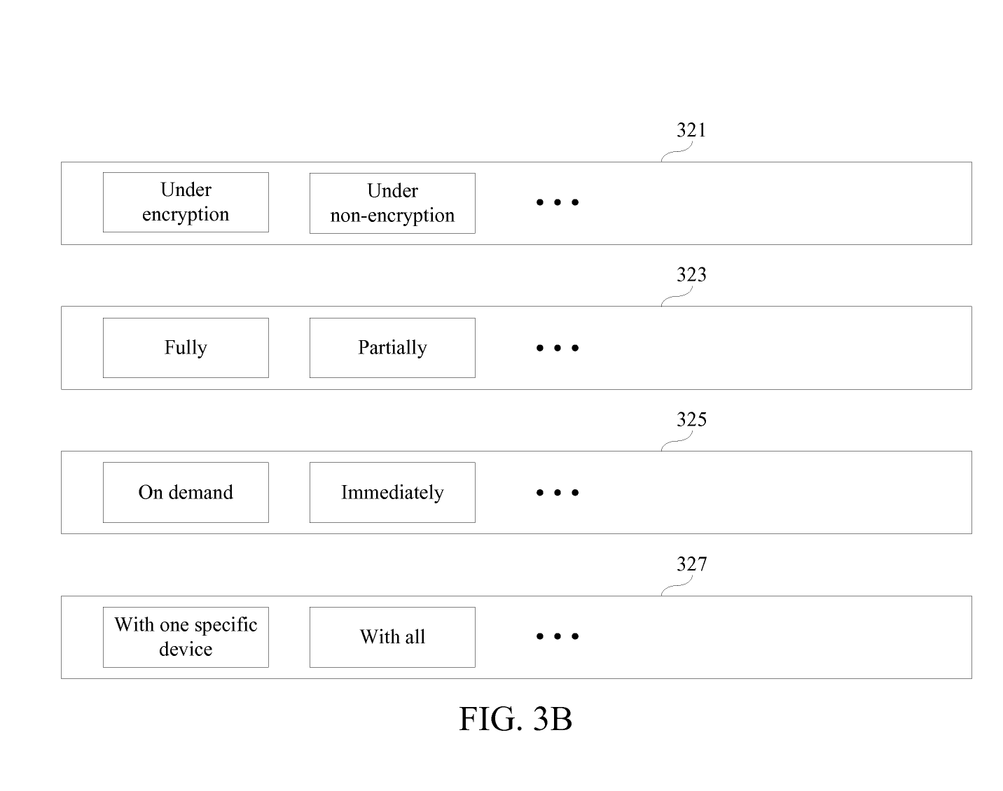

Besides, during the first workflow 30, the processing unit 111 can even create a second workflow according to the at least one first status 60 and/or the at least one user input 80. As same as the first workflow, the second workflow may comprise at least one process (i.e., one or a plurality of processes). FIG. 3A is a diagram illustrating an example of the second workflow according to the first embodiment, where the second workflow 32 is only for the purpose of illustration rather than limitation. As shown in FIG. 3A, the second workflow 32 comprises a process 321, a process 323, a process 325 and a process 327. The process 321 is executed to share a website with one electronic device 13, while the process 323 is executed to determine whether the website is helpful for the electronic device 13. If the determination of the process 323 is negative, the process 325 is executed to share another website with the electronic device 13 and then go back to the process 323. If the determination of the process 323 is positive, the process 327 is executed share the website with other electronic device 13.

Furthermore, each process of the second workflow 32 may be executed with at least one action (i.e., one or a plurality of actions). FIG. 3B is a diagram illustrating an example of various actions for each process of the second workflow 32, where the presented actions are only for the purpose of illustration rather than limitation. As shown in FIG. 3B, the process 321 may be executed to share a website with one electronic device 13 under encryption or under non-encryption. The process 323 may be executed to determine whether the website is fully or partially helpful for the electronic device 13. The process 325 may be executed to share another website with the electronic device 13 on demand or immediately. The process 327 may be executed to share the website with one specific electronic device 13 or with all the electronic devices 13.

As shown in FIG. 2A and FIG. 2B, the first workflow 30 is generated to deal with the processes of file sharing rather than website sharing. Therefore, during the first workflow 30, if one first status 60 which is generated by the electronic device 13 in response to the first share link 40 or one user input 80 which is generated by a user via the user interface 117 in response to the first share link 40 indicates that the electronic device 13 needs the server 11 to share a website with it, the processing unit 111 will generate the second workflow 32 which is appropriate to deal with the processes of website sharing, because the first workflow 30 can not satisfy the need of the electronic device 13. The detailed operations of the second workflow 32 are similar to those of the first workflow 30, so they will not be further described herein.

The server 11 may further comprise the following operations during the first workflow 30. Specifically, during the first workflow 30, the processing unit 111 may further generate at least one second share link 42 (i.e., one or a plurality of second share links) according to the first workflow 30; the network interface unit 113 may further transmit the at least one second share link 42 to the at least one electronic device 13 via the network 19 according to the first workflow 30; the monitor unit 115 may further monitor at least one second status 62 which is generated by the at least one electronic device 13 in response to the at least one second share link 42. In addition, the processing unit 111 may further adjust the first workflow 30 according to the at least one second status 62.

For example, if one first status 60 which is generated by the electronic device 13 in response to the first share link 40 or one user input 80 which is generated by a user via the user interface 117 in response to the first share link 40 indicates that the electronic device 13 fails to receive the first share link 40 connected to the file, the process 305 is executed to send a reminder to the electronic device 13. During the process 305, the processing unit 111 may generate one second share link 42 connected to the reminder; the network interface unit 113 transmits the second share link 42 to the electronic device 13 via the network 19; the monitor unit 115 continuously monitors at least one second status 62 which is generated by the electronic device 13 in response to the second share link 42; and the processing unit 111 adaptively and dynamically adjusts the first workflow 30 according to the at least one second status 62.

The server 11 may further comprise the following operations during the second workflow 32. Specifically, the processing unit 111 may further generate at least one second share link 42 (i.e., one or a plurality of second share links) according to the second workflow 32; the network interface unit 113 may further transmit the at least one second share link 42 to the at least one electronic device 13 via the network 19 according to the second workflow 32; the monitor unit 115 may further monitor at least one second status 62 which is generated by the at least one electronic device 13 in response to the at least one second share link 42. In addition, the processing unit 111 may further adjust the second workflow 32 according to the at least one second status 62.

For example, if one first status 60 which is generated by the electronic device 13 in response to the first share link 40 or one user input 80 which is generated by a user via the user interface 117 in response to the first share link 40 indicates that the website transmitted via the first share link 40 is not helpful for the electronic device 13, the process 325 is executed to share another website with the electronic device 13. During the process 325, the processing unit 111 may generate one second share link 42 connected to another website; the network interface unit 113 transmits the second share link 42 to the electronic device 13 via the network 19; the monitor unit 115 continuously monitors at least one second status 62 which is generated by the electronic device 13 in response to the second share link 42; and the processing unit 111 adaptively and dynamically adjusts the second workflow 32 according to the at least one second status 62.

A second embodiment of the present invention is a share link management method for a server. The share link management method described in the second embodiment may be applied to the server 11 set forth in the first embodiment. Therefore, the server described in second embodiment may be considered to be the server 11 set forth in the first embodiment. The server described in the second embodiment may comprise a processing unit, a network interface unit electrically connected with the processing unit and a monitor unit electrically connected with the network interface unit and the processing unit.

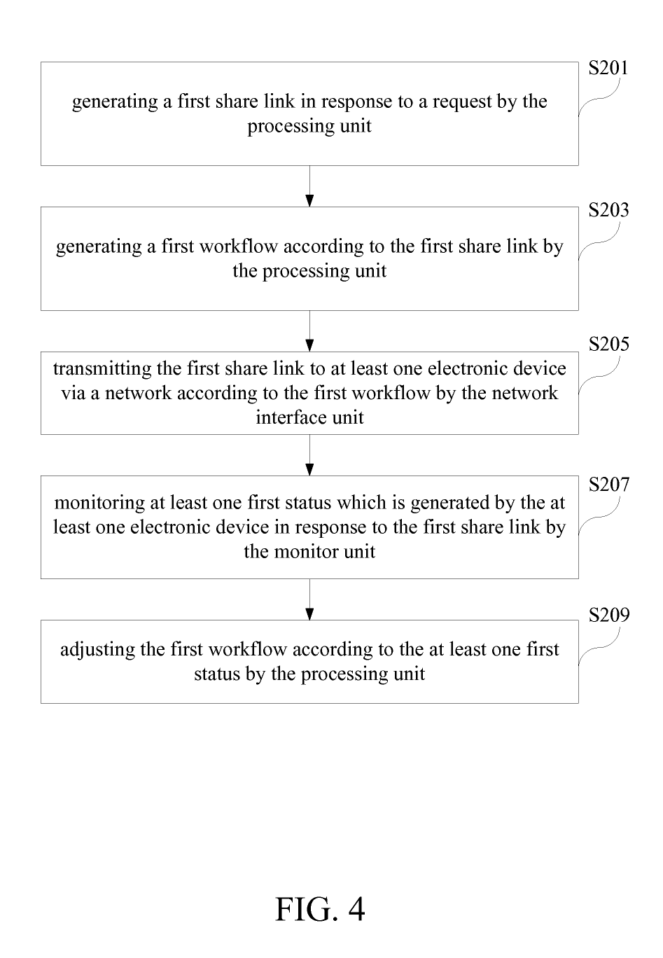

A flowchart of the share link management method is shown in FIG. 4. As shown in FIG. 4, the share link management method comprises a step S201, a step S203, a step S205, a step S207 and a step S209. Step S201 is executed to generate a first share link in response to a request by the processing unit; step S203 is executed to generate a first workflow according to the first share link by the processing unit; step S205 is executed to transmit the first share link to at least one electronic device via a network according to the first workflow by the network interface unit; step S207 is executed to monitor at least one first status which is generated by the at least one electronic device in response to the first share link by the monitor unit; and step S209 is executed to adjust the first workflow according to the at least one first status by the processing unit.

In an example of the second embodiment, the server further comprises a user interface unit electrically connected with the monitor unit. In addition, the share link management method further comprises the following steps: monitoring at least one user input which is generated by at least one user via the user interface in response to the first share link by the monitor unit; and adjusting the first workflow according to the at least one user input by the processing unit.

In an example of the second embodiment, the share link management method further comprises the following steps: generating a second workflow according to the at least one first status by the processing unit.

In an example of the second embodiment, the share link management method further comprises the following steps: generating at least one second share link according to the first workflow by the processing unit; transmitting the at least one second share link to the at least one electronic device via the network according to the first workflow by the network interface unit; monitoring at least one second status which is generated by the at least one electronic device in response to the at least one second share link by the monitor unit; and adjusting the first workflow according to the at least one second status by the processing unit.

In an example of the second embodiment, the server further comprises a user interface unit electrically connected with the monitor unit. In addition, the share link management method further comprises the following steps: generating at least one second share link according to the first workflow by the processing unit; transmitting the at least one second share link to the at least one electronic device via the network according to the first workflow by the network interface unit; monitoring at least one second status which is generated by the at least one electronic device in response to the at least one second share link by the monitor unit; adjusting the first workflow according to the at least one second status by the processing unit; monitoring at least one user input which is generated by at least one user via the user interface in response to the first share link or the second share link by the monitor unit; and adjusting the first workflow according to the at least one user input by the processing unit.

In an example of the second embodiment, the share link management method further comprises the following steps: generating at least one second share link according to the first workflow by the processing unit; transmitting the at least one second share link to the at least one electronic device via the network according to the first workflow by the network interface unit; monitoring at least one second status which is generated by the at least one electronic device in response to the at least one second share link by the monitor unit; adjusting the first workflow according to the at least one second status by the processing unit; and generating a second workflow according to the at least one first status or the at least one second status by the processing unit.

In addition to the aforesaid steps, the share link management method of the second embodiment further comprises other steps corresponding to all the operations of the server 11 set forth in the first embodiment and accomplishes all the corresponding functions. Since the steps which are not described in the second embodiment can be readily appreciated by persons of ordinary skill in the art based on the explanations of the first embodiment, they will not be further described herein.

According to the above descriptions, the present invention provides a server and a share link management method thereof. The server and the share link management method pre-generate a workflow for the sequent social behaviors between the server and other electronic devices according to a share link which is generated in response to a request; monitor various statuses which are generated by the electronic devices in response to the share link; and adaptively and dynamically adjust the workflow according to the monitored statuses to deal with different needs of the electronic devices.

Unlike conventional share link procedures, the present invention can provide information which indicates what is happened after a shark link is transmitted through monitoring various statuses which are generated by the electronic devices in response to the share link. In addition, the present invention generates a workflow which is adjustable according to the monitored statuses to deal with different needs of the electronic devices. Consequently, in contrast with conventional share link procedures, the present invention effectively provides a smarter share link procedure to meet the needs of online social.

The above disclosure is related to the detailed technical contents and inventive features thereof. Persons skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A server, comprising:
a processing unit, configured to:
generate a first share link in response to a request; and
generate a first workflow according to the first share link;
a network interface unit, electrically connected with the processing unit and configured to transmit the first share link to at least one electronic device via a network according to the first workflow; and
a monitor unit, electrically connected with the network interface unit and the processing unit and configured to monitor at least one first status which is generated by the at least one electronic device in response to the first share link;
wherein the processing unit is further configured to adjust the first workflow according to the at least one first status.

2. The server as claimed in claim 1, wherein:
the processing unit is further configured to generate at least one second share link according to the first workflow;
the network interface unit is further configured to transmit the at least one second share link to the at least one electronic device via the network according to the first workflow; and
the monitor unit is further configured to monitor at least one second status which is generated by the at least one electronic device in response to the at least one second share link; and
wherein the processing unit is further configured to adjust the first workflow according to the at least one second status.

3. The server as claimed in claim 1, further comprising a user interface unit electrically connected with the monitor unit; wherein the monitor unit is further configured to monitor at least one user input which is generated by at least one user via the user interface in response to the first share link, and the processing unit is further configured to adjust the first workflow according to the at least one user input.

4. The server as claimed in claim 2, further comprising a user interface unit electrically connected with the monitor unit; wherein the monitor unit is further configured to monitor at least one user input which is generated by at least one user via the user interface in response to the first share link or the at least one second share link, and the processing unit is further configured to adjust the first workflow according to the at least one user input.

5. The server as claimed in claim 1, wherein the processing unit is further configured to generate a second workflow according to the at least one first status.

6. The server as claimed in claim 2, wherein the processing unit is further configured to generate a second workflow according to the at least one first status or the at least one second status.

7. A share link management method for a server, the server comprising a processing unit, a network interface unit electrically connected with the processing unit and a monitor unit electrically connected with the network interface unit and the processing unit, the share link management method comprising:
(a1) generating a first share link in response to a request by the processing unit;
(a2) generating a first workflow according to the first share link by the processing unit;
(a3) transmitting the first share link to at least one electronic device via a network according to the first workflow by the network interface unit;
(a4) monitoring at least one first status which is generated by the at least one electronic device in response to the first share link by the monitor unit; and
(a5) adjusting the first workflow according to the at least one first status by the processing unit.

8. The share link management method as claimed in claim 7, further comprising:
(b1) generating at least one second share link according to the first workflow by the processing unit;
(b2) transmitting the at least one second share link to the at least one electronic device via the network according to the first workflow by the network interface unit;
(b3) monitoring at least one second status which is generated by the at least one electronic device in response to the at least one second share link by the monitor unit; and
(b4) adjusting the first workflow according to the at least one second status by the processing unit.

9. The share link management method as claimed in claim 7, wherein the server further comprises a user interface unit electrically connected with the monitor unit; wherein the share link management method further comprises:
(c1) monitoring at least one user input which is generated by at least one user via the user interface in response to the first share link by the monitor unit; and
(c2) adjusting the first workflow according to the at least one user input by the processing unit.

10. The share link management method as claimed in claim 8, wherein the server further comprises a user interface unit electrically connected with the monitor unit; wherein the share link management method further comprises:
(d1) monitoring at lease one user input which is generated by at lease one user via the user interface in response to the first share link or the second share link by the monitor unit; and
(d2) adjusting the first workflow according to the at lease one user input by the processing unit.

11. The share link management method as claimed in claim 7, further comprising:
(e1) generating a second workflow according to the at least one first status by the processing unit.

12. The share link management method as claimed in claim 8, further comprising:
(f1) generating a second workflow according to the at least one first status or the at least one second status by the processing unit.
